(19) United States
(12) Patent Application Publication
(10) Pub. No.: US 2016/0266542 A1
(43) Pub. Date: Sep. 15, 2016

(54) HOLOGRAPHIC IMAGE GENERATION AND RECONSTRUCTION

(71) Applicant: EMPIRE TECHNOLOGY DEVELOPMENT LLC, Wilimington (DE)

(72) Inventor: Eiji YAMAICHI, Tokyo (JP)

(73) Assignee: EMPIRE TECHNOLOGY DEVELOPMENT LLC, Wilmington, DE (US)

(21) Appl. No.: 15/030,880

(22) PCT Filed: Oct. 30, 2013
(86) PCT No.: PCT/US2013/067364

§ 371 Date: Apr. 21, 2016

(51) Int. Cl. G03H 1/04; G03H 1/00

(52) U.S. Cl. CPC G03H 1/0443; G03H 1/0005; G03H 2001/0088; G03H 2001/0268

(57) ABSTRACT

Technologies are generally described for generating a holographic image of an object and a background image of the object. In various examples, a holographic image generation apparatus is described, where a light beam from a light source may be provided to a beam splitter, which may split the light beam into a first light beam that can be irradiated on and scattered by the object to generated an object light beam, and a second light beam that can be reflected by a mirror to generate a reference light beam. Some example apparatus can also include a first image sensor configured to detect a first image of interference caused by the reference light beam and the object light beam, and a second image sensor configured to detect a second image of background of the object.

### BACKGROUND

Unless otherwise indicated herein, the approaches described in this section are not prior art to the claims in this application and are not admitted to be prior art by inclusion in this section.

Holography techniques can be used to record holograms representing images of an object and reconstruct the images from the recorded holograms. As an example of conventional holography techniques, transmission-type holography techniques can be used to generate holograms of a two-dimensional or three-dimensional object on a transmitting side, for example, by means of a CCD (charge coupled device) camera. The holograms can be transmitted to a receiving side in the form of video signals. On the receiving side, the holograms can be displayed on a high-definition liquid crystal display panel constituted of pixels having a resolution of the order of the optical diffraction limit, based on fringe patterns contained in the received video signals. In particular, the hologram can be formed by irradiating a reconstruction light that readily causes interference, e.g., coherent light emitted from a laser light source, on the fringe patterns displayed on one side of the display panel. The irradiation of the reconstruction light on the fringe patterns can cause diffraction in the fringe patterns, such that a user can observe the diffracted light as holographic images emitted from the other side of the display panel.

In some conventional holography technologies, a hologram can be formed by interference between light scattered by an object and reference light from a coherent light source. Accordingly, the hologram may be obtained for an image of an object located within a certain range where the light scattered by the object can interfere with the reference light. However, a background image of the object may not be properly incorporated into the hologram.

### SUMMARY

Technologies are generally described for generating a holographic image of an object and reconstructing the holographic image such that the object can be viewed along with the background of the object.

Various example apparatus configured to generate a holographic image of an object described herein may include one or more of a light source, a beam splitter, a mirror, a first image sensor, a video signal generator and/or a second image sensor. The light source may be configured to generate a light beam. The beam splitter may be configured to receive the light beam from the light source and split the light beam into a first light beam and a second light beam. The beam splitter may also be configured to irradiate the first light beam on the object such that at least part of the first light beam is scattered by the object to generate an object light beam. The minor may be configured to receive the second light beam from the beam splitter, and reflect at least part of the second light beam to generate a reference light beam. The first image sensor may be configured to receive the reference light beam and the object light beam, and also configured to detect a first image of interference caused by the reference light beam and the object light beam. The video signal generator may be configured to convert the detected first image into a first image signal associated with the light source. The second image sensor may be configured to detect a second image of background of the object and convert the second image into a second image signal.

In some examples, an apparatus configured to reconstruct a holographic image of an object is described such as any example apparatus described herein that may be adapted to utilize one or more of a receiver, a virtual image radiation source such as a virtual image light source, a scanner, a first screen, a reconstruction light source and/or a second screen. The receiver may be configured to receive a first input signal representative of a hologram of the object and a second input signal representative of background of the object. The virtual image radiation source may be configured to generate a virtual image light beam, or other virtual image radiation beam such as a virtual image electron beam, responsive to the first input signal. The scanner may be configured to receive the virtual image radiation beam and reflect or otherwise redirect the virtual image radiation beam to generate a scan beam. The first screen may be coated with a photochromic material, and may be configured to receive the scan beam from the scanner The first screen may include one or more visible light transmittance characteristics that can be adjusted in response to the scan beam and effective to form the hologram of the object on the first screen. The reconstruction light source may be configured to generate a reconstruction light beam to irradiate the first screen to reconstruct the holographic image of the object. The second screen may be arranged to overlap the first screen, and also may be configured to display the background of the object responsive to the second input signal.

In some examples, methods for generating a holographic image of an object are described. Example methods may include generating, by a light source, a light beam. The light beam irradiated from the light source may be split, by a beam splitter, into a first light beam and a second light beam such that the first light beam is irradiated on the object. The second light beam may be received and reflected, by a mirror, to generate a reference beam. An interference image caused by interference between the reference beam and the first light beam scattered by the object may be detected by a first image sensor. The detected interference image may be converted, by a video signal generator, into a first image signal associated with the light source. A second image of background of the object may be detected, by a second image sensor, and converted into a second image signal.

In some examples, methods for reconstructing a holographic image of an object are described. Example methods may include receiving, by a receiver, a first input signal representative of a hologram of the object and a second input signal representative of background of the object. A virtual image radiation beam, such as a virtual image light beam or electron beam, may be generated, by a virtual image radiation source such as a virtual image light source or a virtual image electron beam source, responsive to the first input signal. The virtual image radiation beam may be received and reflected (or otherwise redirected), by a scanner, to generate a scan beam. The scan beam from the scan unit may be received, by a first screen coated with a material, such as a photochromic material or a cathodochromic material, and the hologram of the object may be formed on the first screen as a result of variations in the visible light transmittance characteristics of the first screen in response to the scan beam. A reconstruction light beam may be generated, by a reconstruction light source, to irradiate the first screen to reconstruct the holographic image of the object. The background of the object may be displayed, by a second screen arranged to overlap the first screen, responsive to the second input signal.

In some examples, a computer-readable storage medium is described that may be adapted to store a program for causing a processor to generate a holographic image of an object. The processor may include various features as further described herein. The program may include one or more instructions for generating, by a light source, a light beam, splitting, by a beam splitter, the light beam irradiated from the light source into a first light beam and a second light beam such that the first light beam is irradiated on the object, and receiving and reflecting, by a mirror, the second light beam to generate a reference beam. The program may further include one or more instructions for detecting, by a first image sensor, an interference image caused by interference between the reference beam and the first light beam scattered by the object, converting, by a video signal generator, the detected interference image into a first image signal associated with the light source, and detecting, by a second image sensor, a second image of background of the object and converting the second image into a second image signal.

In some examples, a computer-readable storage medium is described that may be adapted to store a program for causing a processor to reconstruct a holographic image of an object. The processor may include various features as further described herein. The program may include one or more instructions for receiving, by a receiver, a first input signal representative of a hologram of the object and a second input signal representative of background of the object, generating, by a virtual image radiation source, a virtual image radiation beam responsive to the first input signal, and receiving and redirecting (e.g. reflecting or deflecting), by a scanner, the virtual image radiation beam to generate a scan beam. Some examples include generating, by a virtual image light source, a virtual image light beam responsive to the first input signal, and receiving and reflecting, by a scanner, the virtual image light beam to generate a scan beam. In some examples, the virtual image radiation beam may be an electron beam and redirecting the beam may include magnetic and/or electrical field induced deflection of the electron beam. The program may further include one or more instructions for receiving, by a first screen coated with a photochromic material, the scan beam from the scanner, and forming the hologram of the object on the first screen as a result of variations in the visible light transmittance characteristics of the first screen in response to the scan beam. The program may further include one or more instructions for generating, by a reconstruction light source, a reconstruction light beam to irradiate the first screen to reconstruct the holographic image of the object, and displaying, by a second screen arranged to overlap the first screen, the background of the object responsive to the second input signal

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows a block diagram of an illustrative example holographic image generation apparatus;

FIGS. 2A and 2B schematically show cross-sectional views of illustrative example optical paths including one or more lenses;

FIG. 3 schematically shows a block diagram of an illustrative example holographic image system including a holographic image generation apparatus coupled to a holographic image reconstruction apparatus through a network;

FIG. 4 schematically shows a block diagram of an illustrative example holographic image reconstruction apparatus;

FIG. 5 schematically shows a cross-sectional view of an illustrative example transparent screen that can be used as a first screen of a holographic image reconstruction apparatus;

FIGS. 6A and 6B illustrate an electronic band structure of a photochromic material used in an illustrative example transparent screen;

FIG. 7 illustrates an example flow diagram of a method adapted to generate holographic images;

FIG. 8 illustrates an example flow diagram of a method adapted to reconstruct holographic images;

FIG. 9 shows a schematic block diagram illustrating an example computing system that can be configured to implement methods for generating and/or reconstructing holographic images;

FIG. 10 illustrates computer program products that can be utilized to generate holographic images; and

FIG. 11 illustrates computer program products that can be utilized to reconstruct holographic images,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices and computer program products related to generating a holographic image of an object and reconstructing the holographic image such that the object can be viewed along with the background of the object.

Briefly stated, technologies are generally described for generating a holographic image of an object and a background image of the object. Example devices/systems described herein may use one or more of a light source, a beam splitter, a minor, a first image sensor, a video signal generator and/or a second image sensor. In various examples, a holographic image generation apparatus is described, where the apparatus may be configured to transmit a light beam from a light source to a beam splitter, which may be configured to split the light beam into a first light beam that can be irradiated on and scattered by the object to generated an object light beam, and a second light beam that can be reflected by a mirror to generate a reference light beam. Some example apparatus can also include a first image sensor that may be configured to detect a first image of interference caused by the reference light beam and the object light beam, and a second image sensor that may be configured to detect a second image of background of the object.

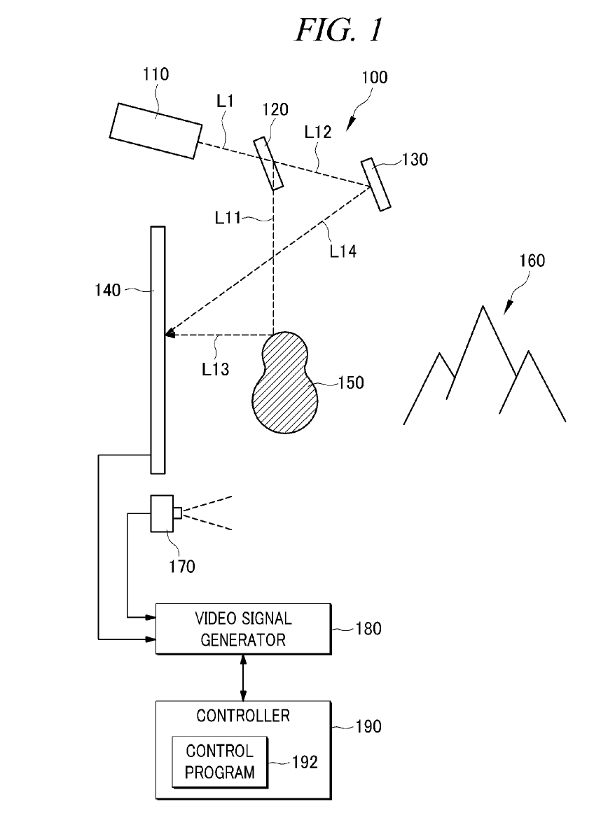

FIG. 1 schematically shows a block diagram of an illustrative example holographic image generation apparatus, arranged in accordance with at least some embodiments described herein. As depicted, a holographic image generation apparatus 100 may include one or more of a light source 110, a beam splitter 120, a minor 130, a first image sensor 140, a second image sensor 170, a video signal generator 180, and/or a controller 190. The first image sensor 140 and the second image sensor 170 each include a respective output that is coupled to corresponding inputs of the video signal generator 180. The video signal generator 180 also includes an interface that is coupled to the controller 190.

In operation, light source 110 is configured to irradiate (or transmit) a light beam L1 towards beam splitter 120. Beam splitter 120 may be configured to split light beam L1 received from light source 110 into a first light beam L11 and a second light beam L12. First light beam L11 may be irradiated on an object 150, which may be arranged in the vicinity of first image sensor 140. In the meantime, second light beam L12 may be irradiated on minor 130. Minor 130 may be configured to reflect second light beam L12 to generate a reference beam L14. A portion of first light beam L11, which may be referred to as an object light beam L13, can be scattered by object 150. At least a portion of object light beam L13, and at least a portion of reference light beam L14 may be approximately co-incident on a portion of first image sensor 140 effective to form in an interference pattern about first image sensor 140.

When two light beams (e.g., L14 and L13) reach the surface of first image sensor 140, the light waves may intersect and interfere with each other. The interference pattern formed by the intersecting light waves may represent the manner in which the scene's light from object 150 interferes with the original light source. First image sensor 140 may receive a first image of the interference pattern and transmit the first image to video signal generator 180, which may be configured to convert the first image into a first image signal associated with light source 110.

In some examples, second image sensor 170 may be configured to detect a second image of background 160 of object 150 and convert the detected second image into a second image signal. In various examples, second image sensor 170 may be further configured to transmit the second image to video signal generator 180, which may be configured to convert the second image into the second image signal.

In the above embodiments, the first image signal representative of a hologram of object 150 can be generated along with the second image signal representative of background 160 of object 150. The first image signal and the second image signal may be recorded in a video signal recorder (e.g., a storage unit) and/or transmitted to a holographic image reconstruction apparatus such that a holographic image represented by the first image signal can be displayed while being superimposed on a background image represented by the second image signal, which will be described later in more detail.

In some embodiments, holographic image generating apparatus 100 may optionally include controller 190, which can be configured to control operation of video signal generator 180. Controller 190 may be further configured to store a control program 192 to control operation of holographic image generation apparatus 100.

In FIG. 1, one light source 110 and corresponding beam splitter 120 are illustrated for the sake of explanation. However, the number of light sources and beam splitters may not be limited thereto. In some examples, two separate light sources may be arranged to provide light beams L11 and L12, respectively. In some other examples, two separate light sources may be arranged to provide light beams L11 and L14, respectively. In various examples, two or more pairs of light sources and/or beam splitters may be arranged to provide any number of the sourced light beams depending on the desired implementation.

In some embodiments, first and second image sensors 140 and 170 may include one or more image sensors. For example, first and second image sensors 140 and 170 may include one or more CCDs (charge coupled devices) and any other suitable types of imaging sensors or sensor arrays. More specifically, first image sensor 140 may include a two-dimensional sensor array. In such case, the array of image sensors may be arranged in a two-dimensional shape such as rectangle. Alternatively, the array of image sensors may be arranged in a three-dimensional shape, such as a polygonal prism, a cylinder or any other shapes, which may be arranged to surround object 150.

In some embodiments, light source 110 may be configured to radiate a coherent light beam such as a laser beam, for example a visible laser beam. In some examples, light source 110 may be a visible light source, such as a blue-violet light source, and may include a light source configured to generate light having a wavelength of about 440 nm. In some examples, the light source wavelength may be selected to match that of a reconstruction light beam. Also, beam splitter 120 may be implemented using a half-minor including an aluminum layer formed on a glass substrate.

In some embodiments, one or more lenses may be positioned either in an optical path between beam splitter 120 and object 150 or in an optical path between minor 130 and first image sensor 140.

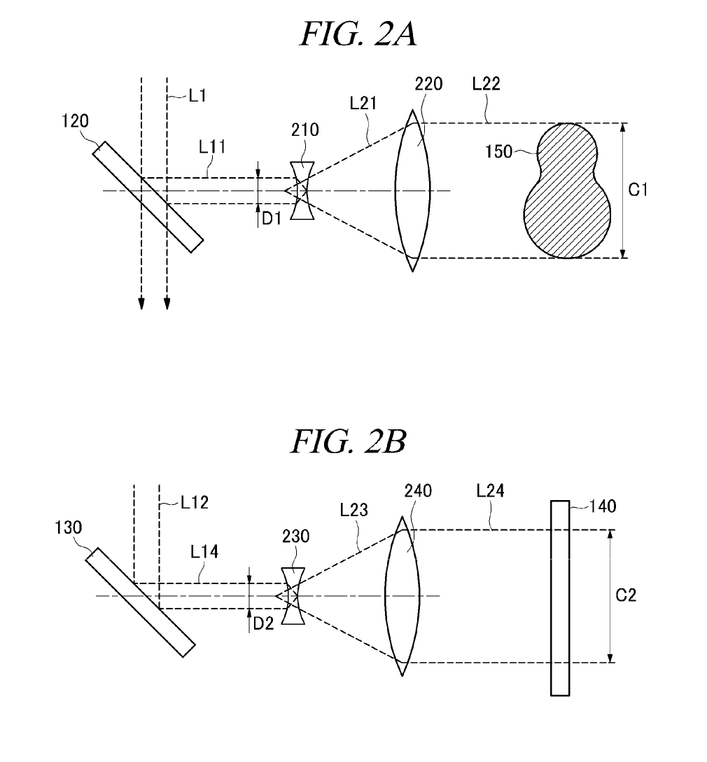

FIGS. 2A and 2B schematically show cross-sectional views of illustrative example optical paths including one or more lenses, arranged in accordance with at least some embodiments described herein. As depicted in FIG. 2A, the optical path between beam splitter 120 and object 150 may include a concave lens 210 configured to convert first light beam L11 from beam splitter 120 to a light beam L21 that diverges towards a convex lens 220. In this manner, first light beam L11 with a width D1 may be magnified and diverged to have a cross-sectional width that is at least equal to a cross-sectional width C1 of object 150. Convex lens 220 may be configured to modify light beam L21 to a light beam L22 of parallel rays having a width that is at least equal to a cross-sectional width C1, which may be irradiated on an entire surface of object 150 along cross-sectional width C1.

Although FIG. 2A illustrates the configuration of the optical path between beam splitter 120 and object 150, a similar configuration may be used in the optical path between minor 130 and first image sensor 140. As illustrated in FIG. 2B, the optical path between minor 130 and first image sensor 140 may include a concave lens 230 configured to convert reference beam L14 (which is second light beam L12 generated from beam splitter 120 and reflected on minor 130) to a light beam L23 that diverges towards a convex lens 240. In this manner, reference beam L14 with a width D2 may be magnified and diverged to have a cross-sectional width that is at least equal to a width C2 of an effective image sensing area on first image sensor 140. Convex lens 240 may be configured to modify light beam L23 to a light beam L24 of parallel rays having a width that is at least equal to width C2, which may be irradiated on the entire effective image sensing area on first image sensor 140. Other optical configurations can be used as a beam expander, configured to obtain expanded light beams for e.g. illuminating the object or image sensor as a reference beam. For example, a beam expander may include two convex lenses spaced apart along the beam path.

In some embodiments, the first and second image signals generated by holographic image generation apparatus 100 may be recorded in a video signal recorder (e.g., a local storage unit) and/or transmitted to a holographic image reconstruction apparatus.

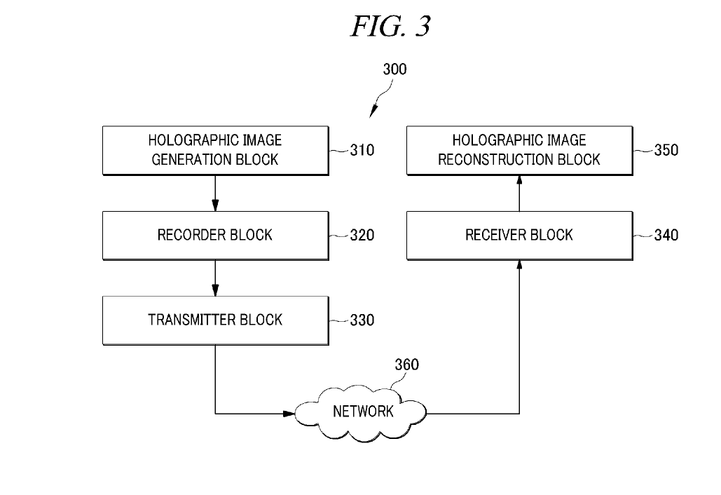

FIG. 3 schematically shows a block diagram of an illustrative example holographic image system including a holographic image generation apparatus coupled to a holographic image reconstruction apparatus through a network, arranged in accordance with the present disclosure. As illustrated, an example holographic image system 300 may include one or more of a holographic image generation block 310, a recorder block 320, a transmitter block 330, a receiver block 340, and/or a holographic image reconstruction block 350. Holographic image generation block 310 may include an output that is coupled to an input of recorder block 320. Recorder block 320 may also include an output that is coupled to an input of transmitter block 330. Transmitter block 330 may also include an output that is coupled to an input of receiver block 340, optionally via one or more networks 360. Receiver block 340 may also include an output that is coupled to an input of holographic image reconstruction block 350.

In operation, holographic image generation block 310 may perform a similar function to holographic image generation apparatus 100 as shown in FIG. 1. Holographic image generation block 310 may be configured to generate first and second image signals in a manner as described above with reference to FIG. 1. Thus generated image signals may be transmitted and recorded in recorder block 320. The image signals recorded in recorder block 320 may be read by transmitter block 330 and sent to a remote device, such as receiver block 340 or holographic image reconstruction block 350, through one or more networks 360. Receiver block 340 may be configured to receive the image signals from transmitter block 330 and transmit the image signals to holographic image reconstruction block 350.

In some embodiments, holographic image reconstructing apparatus 350 may be configured to reconstruct holographic images of object 150 based on the received first image signals and also display background images of object 150 being superimposed on the holographic images of object 150.

The functionality of above system examples are described in terms of blocks that may be implemented as hardware, software, and/or combinations thereof. Although illustrated as discrete blocks, the various blocks may be divided into additional blocks, combined into fewer blocks, or eliminated, depending on the desired implementation. Moreover, although the arrangement of the blocks suggest sequential operation, one or more of the various blocks may be operated sequentially, in parallel, and in any other reasonable combination of sequential/parallel operation as may be desired for a specific implementation.

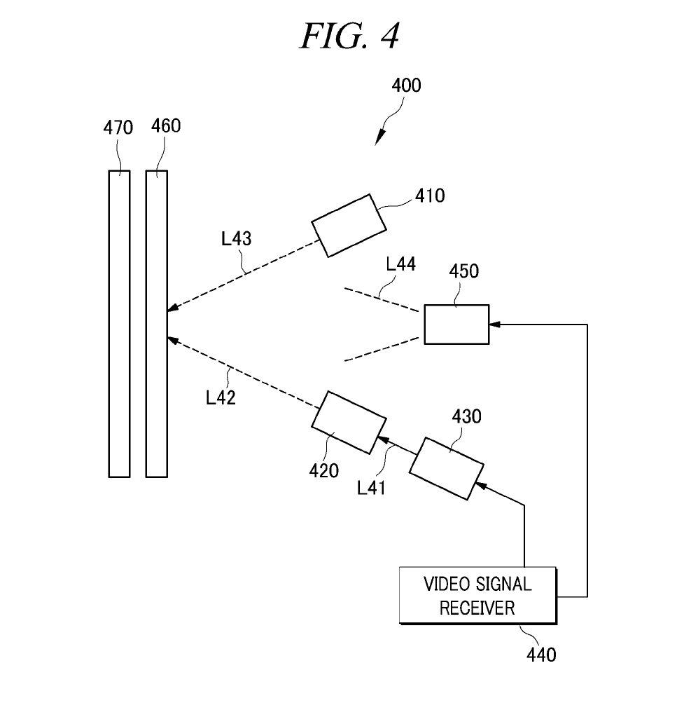

FIG. 4 schematically shows a block diagram of an illustrative example holographic image reconstruction apparatus, arranged in accordance with at least some embodiments described herein. As shown in FIG. 4, a holographic image reconstruction apparatus 400 may include one or more of a reconstruction light source 410, a scanner 420, a virtual image light source 430, a video signal receiver 440, an image projector 450, a first screen 460 and/or a second screen 470. Scanner 420 may include an input that is coupled to an output of virtual image light source 430. Also, Virtual image light source 430 may include an input that is coupled to an output of video signal receiver 440, which may include another output that is coupled to an input of image projector 450.

In operation, virtual image light source 430 may be configured to generate a virtual image light beam L41 such as an ultraviolet laser beam, based on a holographic image signal such as the first signal representative of a hologram of object 150. In some embodiments, the holographic image signals may be provided from video signal receiver 440, which may receive and store the holographic image signal from a holographic image generation apparatus such as holographic image generation apparatus 100 in FIG. 1. Thus generated virtual image light beam L41 may have intensities which may vary based on the levels of the holographic image signal.

In some embodiments, virtual image light source 430 may be configured to provide virtual image light beam L41 to irradiate onto a scanner 420. Scanner 420 may include a scanning minor configured to reflect virtual image light beam L41 and generate a scan beam L42 that is irradiated on first screen 460. Scanner 420 may be configured to be magnetically actuated, electrically actuated or electromagnetically actuated, wherein the actuation of scanner 420 is effective to steer scan beam L42 (e.g., actuation may facilitate a change the direction of scan beam L42 generated from scanner 420).

In some embodiments, first screen 460 may be configured in a shape of a two-dimensional panel. Further, first screen 460 may be coated with a photochromic material and configured to form a hologram of an object, such as object 150, due to visible light transmittance characteristics of first screen 460 adjusted in response to scan beam L42. For example, first screen 460 may be a transparent screen including a photochromic material formed on a transparent layer, which will be described later.

In some embodiments, reconstruction light sources 410 may be configured to irradiate a reconstruction light beam L43, such as a visible laser beam, on first screen 460. When the hologram formed on first screen 460 are irradiated with the reconstruction light beam, a holographic image of the object may be reconstructed. In some examples, a virtual image radiation source may be an electron beam source, for example comprising an electron emission device and electron accelerator, the virtual image radiation beam may be an electron beam, and the first screen may include a cathodochromic material.

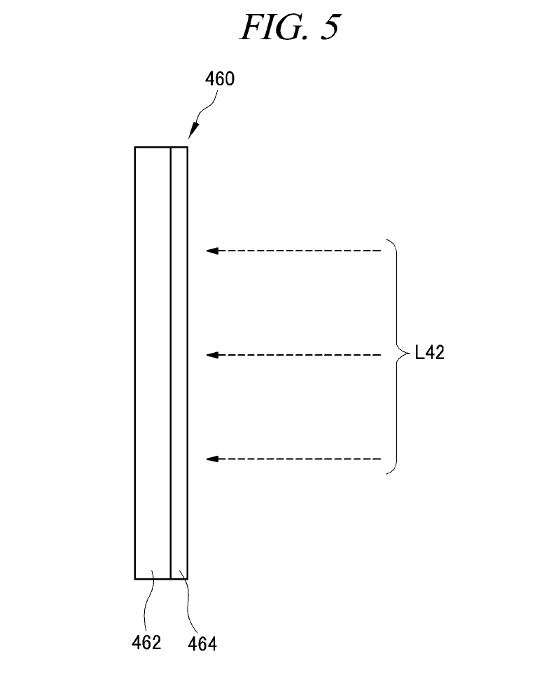

FIG. 5 schematically shows a cross-sectional view of an illustrative example transparent screen that can be used as first screen 460 of holographic image reconstruction apparatus 400, arranged in accordance with at least some embodiments described herein. As illustrated, transparent screen 460 may include a transparent layer 462, such as a quartz glass material, a borosilicate glass material, a transparent plastic material or PET (polyethylene terephthalate) material, coated with a photochromic material 464. As described above, the light transmittance characteristics of photochromic material 464 coated on transparent layer 462 may change when light beam L42 with a specific energy range, such as an ultraviolet light with energy level of about 3.5 eV to about 5 eV. A hologram may be formed on transparent screen 460 coated with photochromic material 464 having the above-described characteristics, by changing the light transmittance characteristics of photochromic material 464 in response to the varying intensities (e.g., about 7.5×10¹² photons/cm²·sec or more) of light beam L42.

In some embodiments, photochromic material 464 may include one or more of a crystalline, polycrystalline, or amorphous materials including potassium (K), strontium (Sr), barium (Ba), tantalum (Ta), and/or titanium (Ti). For example, photochromic material 464 may include at least one of potassium tantalate (KTaO₃), strontium titanate (SrTiO₃), or barium titanate (BaTiO₃), doped with an impurity such as nickel (Ni) or iron (Fe), which may be represented by KTaO₃:Fe, KTaO₃:Ni, SrTiO₃:Fe, SrTiO₃:Ni, BaTiO₃:Fe, or BaTiO₃:Ni. Additionally or alternatively, photochromic material 464 may include an organic photochromic material such as HABI (hexaarylbiimidazole).

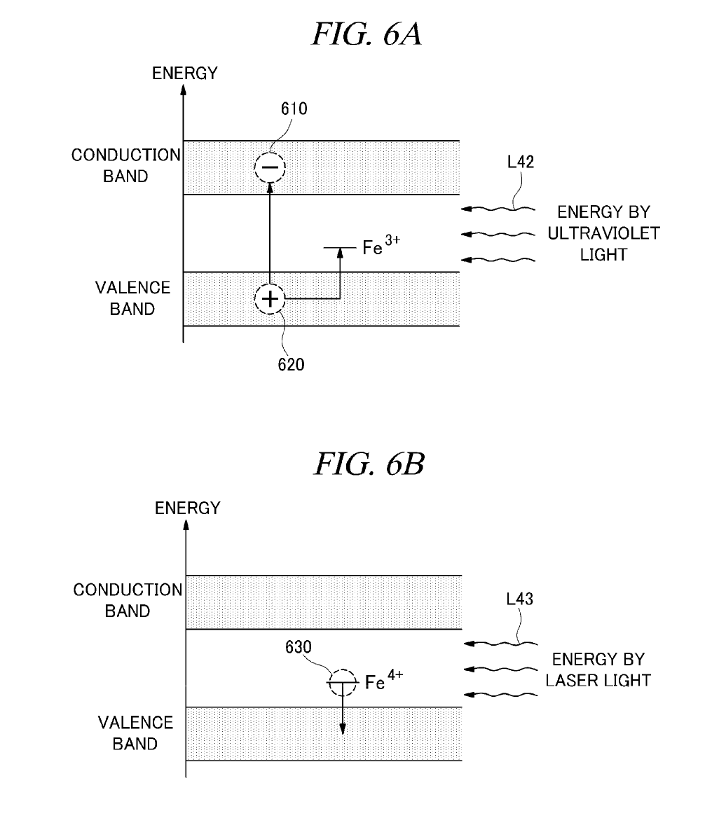

FIGS. 6A and 6B illustrate an electronic band structure of a photochromic material 464 used in an illustrative example transparent screen 460, arranged in accordance with at least some embodiments described herein. As depicted in FIG. 6A, when light beam L42 (which may representing hologram images) is irradiated on photochromic material 464, such as KTaO₃:Fe, SrTiO₃:Fe, BaTiO₃:Fe, an electron 610 in the irradiated portion of photochromic material 464 may be excited by energy of light beam L42, and may move from the valence band to the conduction band of photochromic material 464, thus forming a hole 620 in the valence band. Hole 620 formed in the valence band may be trapped by a trivalent impurity Fe³⁺, which changes Fe³⁺ to Fe⁴⁺.

Further, photochromic material 464 in the above-described state may exhibit wide absorption characteristics for a light with visible spectrum. A photochromic (or cathodochromic) material may exhibit a photochromic effect (or cathodochromic effect) having one or more light absorption peaks, and a reconstruction beam may include light having a wavelength (or wavelength range, or portion thereof) that is wavelength matched to the light absorption peak. In some examples, a photochromic material and may specifically have a light absorption peak at the wavelength of about 440 nm (or in other examples, about 630 nm). Thus, as illustrated in FIG. 6B, when reconstruction light beam L43 such as a visible laser light beam having a wavelength of about 440 nm, Fe⁴⁺ may excite a hole 630 in the valence band in response to energy by reconstruction light beam L43.

Accordingly, on photochromic material 464 of first screen 460, a hologram (for example, a holograph encoding phase or amplitude variations of a holographic representation) that exhibits variation in transmittance for visible light with, for example, a specific wavelength, such as about 440 nm, may be formed in accordance with the intensity variation of an ultraviolet light such as virtual image light beam L42. Further, when the hologram formed on first screen 460 is irradiated with a hologram reconstruction light with the specific wavelength, such as reconstruction light L43, a holographic image may be reconstructed and viewable by a user.

As explained above, photochromic material 464 may exhibit light transmittance characteristics at the specific wavelength (e.g., about 440 nm) variable in response to irradiation of an ultraviolet light, whereas the light transmittance at other wavelengths may remain substantially unchanged. Thus, a user can view a background image displayed on second screen 470, which may be superimposed on the hologram image formed on first screen 460.

Referring back to FIG. 4, holographic image reconstruction apparatus 400 may further include an image projector 450, such as a LCD (liquid crystal display) projector, configured to irradiate a light beam L44 effective to project (or transmit) an image representative of the background of the object, such as background 160, onto second screen 470. More specifically, image projector 450 may receive an image signal representative of the background of the object, from video signal receiver 440, and irradiate light beam L44 towards first screen 460, through which light beam L passes to reach the surface of second screen 470. Light beam L44 from image project 450 may be used to project the image representative of the background of the object, which may have a wavelength within the visible light spectrum. In some examples, the background image may not include wavelengths that are the same or similar to those used for hologram formation. In some examples, the background image may be filtered to remove wavelengths close to those that form the holographic image or otherwise may not include such wavelengths.

Alternatively, second screen 470 may include any suitable type of display screen including, but not limited to, an LCD screen, an OLED (organic light emitting diode) screen, PDP (plasma display panel) screen, etc., which may be configured to display the background of the object. In such case, image projector 450 may be omitted in holographic image reconstruction apparatus 400, and the image signal representative of the background of the object may be provided from video signal receiver 440 to second screen 470.

As described above, for the photochromic material coated on first screen 460, the ultraviolet light from virtual image light source 430 may change the transmittance characteristics of first screen 460 at a specific wavelength such as 440 nm or 630 nm, whereas the transparency of first screen 460 may be maintained at the other wavelengths. Therefore, the interference pattern formed by the ultraviolet light on the photochromic material does not interfere with the background image displayed on second screen 470, and thus, a clear background image can be superimposed on a holographic image of an object.

According to the above embodiments, the first image detected by the first image sensor (e.g., first image sensor 140) may be converted into a first image signal associated with the light source (e.g., light source 110). Also, the second image detected by the second image sensor (e.g., second image sensor 170) may be converted into a second image signal. The first and second image signals may be recorded in a video signal recorder (e.g., a local storage unit). The first and second image signals may be transmitted to a holographic image reconstruction apparatus (e.g., holographic image reconstruction apparatus 400).

In some embodiments, the first and second image sensors may include one or more CCDs (charge coupled devices) and/or may be configured in a two-dimensional sensor array. Also, the beam splitter (e.g., beam splitter 120) may include an aluminum layer formed on a glass substrate.

In some embodiments, the light source may include a visible laser light source. Further, the light source may include a light source configured to generate a light having a wavelength of about 440 nm

In some embodiments, the holographic image generation apparatus (e.g., holographic image generation apparatus 100) may further include the controller (e.g., controller 190) configured to control operation of the video signal generator (e.g., video signal generator 180). Further, the controller is configured to store a control program to control operation of the apparatus.

In some embodiments, the holographic image reconstruction apparatus may be configured to receive a first input signal representative of a hologram of the object and a second input signal representative of background of the object and generate a virtual image light beam from the virtual image light source (e.g., virtual image light source 430), responsive to the first input signal. The virtual image light beam may be reflected by the scanner (e.g., scanner 420) to generate a scan beam that are irradiated on the first screen (e.g., first screen 460), which may be coated with a photochromic material, and configured to form the hologram of the object on the first screen due to a visible light transmittance characteristics of the first screen adjusted in response to the scan beam. Further, a reconstruction light beam may be irradiated on the first screen such that holographic image of the object can be reconstructed. Further, the holographic image reconstruction apparatus may include the second screen (e.g., second screen 470) arranged to overlap the first screen and also configured to display the background of the object responsive to the second input signal.

In some embodiments, the first screen may include the photochromic material formed on a transparent layer. The transparent layer may include a quartz glass material or a borosilicate glass material. Alternatively, the transparent layer may include a transparent plastic material or PET (polyethylene terephthalate) material.

In some embodiments, the photochromic material may include one or more materials selected from the group consisting of potassium tantalite (KTaO₃) doped with a first impurity and/or strontium titanate (SrTiO₃) doped with a second impurity. The first and second impurities may include nickel (Ni) or iron (Fe). Alternatively, the photochromic material may include HABI (hexaarylbiimidazole).

In some embodiments, the first screen may be arranged in a shape of a two-dimensional panel. Further, the scanner may be actuated by any reasonable mechanism, for example, magnetically actuated, electrically actuated, or electromagnetically actuated. In some embodiments, the virtual image radiation source may be configured to generate either an ultraviolet laser beam (as a virtual image light source) or an electron beam. Also, the reconstruction light source may include a visible laser light source or any suitable light source configured to generate a light including one or more reconstruction wavelengths suitable for holographic reconstruction, in some example light having a wavelength in the blue-violet spectrum (e.g. having a wavelength in the range 380 nm-500 nm), for example blue light (e.g. having a wavelength range of 450 nm-500 nm), violet light (e.g. having a wavelength range of 380 nm-450 nm), and in some examples a wavelength of about 440 nm. Ranges are inclusive, and in some examples range limits may be approximate. A reconstruction light beam wavelength may be selected to observe optical changes in a material (such as photochromism and/or cathodochromism) induced by the virtual image radiation beam (such as a light beam and/or an electron beam). In some example, the reconstruction beam may be a substantially monochromatic light beam, for example laser radiation.

In some embodiments, the second screen may be further configured to receive an image projected from an LCD (liquid crystal display) projector (e.g., image projector 450), the image being representative of the background of the object. Alternatively, the second screen may include an LCD screen configured to display the background of the object.

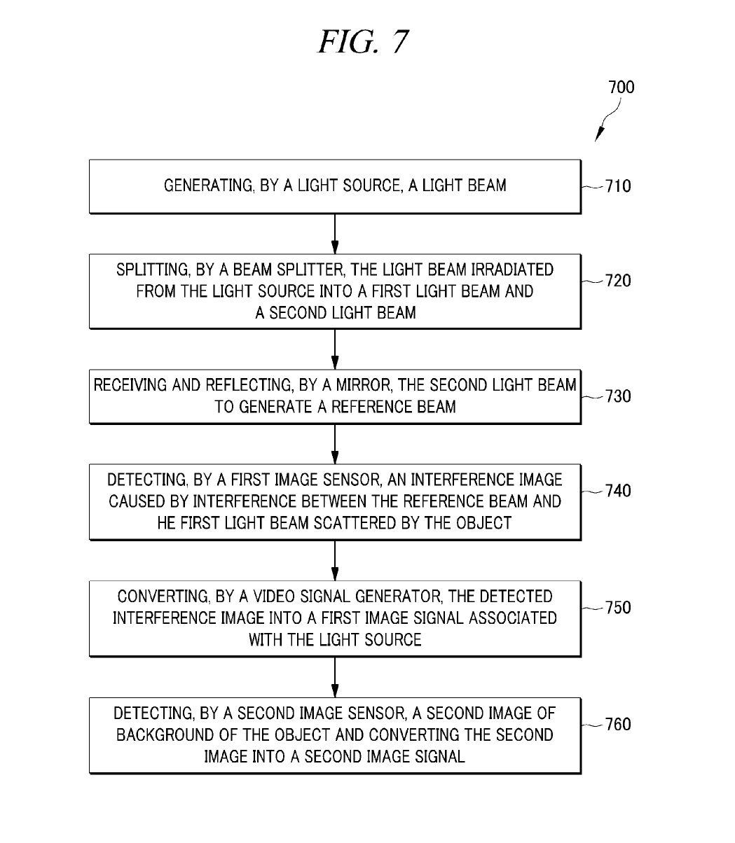

FIG. 7 illustrates an example flow diagram of a method adapted to generate holographic images in accordance with at least some embodiments described herein. An example method 700 in FIG. 7 may be implemented using, for example, a computing device including a processor adapted to generate holographic images.

Method 700 may include one or more operations, actions, or functions as illustrated by one or more of blocks 710, 720, 730, 740, 750 and/or 760. Although illustrated as discrete blocks, various blocks may be divided into additional blocks, combined into fewer blocks, or eliminated, depending on the desired implementation.

In some further examples, the various described blocks may be implemented as a parallel process instead of a sequential process, or as a combination thereof. Method 700 may begin at block 710, “GENERATING, BY A LIGHT SOURCE, A LIGHT BEAM.”

At block 710, a light beam may be irradiated by a light source. As depicted in FIG. 1, light source 110 may be configured to irradiate (or transmit) a light beam towards beam splitter 120. Block 710 may be followed by block 720, “SPLITTING, BY A BEAM SPLITTER, THE LIGHT BEAM IRRADIATED FROM THE LIGHT SOURCE INTO A FIRST LIGHT BEAM AND A SECOND LIGHT BEAM.”

At block 720, the light beam may be split into a first light beam and a second light beam by a beam splitter. As illustrated in FIG. 1, beam splitter 120 may be configured to split light beam L1 received from light source 110 into first light beam L11 and second light beam L12. In some embodiments, first light beam L11 may be irradiated on object 150, which may be arranged in the vicinity of first image sensor 140. In the meantime, second light beam L12 may be irradiated on minor 130. Block 720 may be followed by block 730, “RECEIVING AND REFLECTING, BY A MIRROR, THE SECOND LIGHT BEAM TO GENERATE A REFERENCE BEAM.”

At block 730, the second light beam may be reflected by a minor to generate a reference beam. As illustrated in FIG. 1, minor 130 may be configured to reflect second light beam L12 to generate reference beam L14, such that a portion of first light beam L11, which may be object light beam L13 scattered by object 150, and reference light beam L14 may cause an interference pattern to be formed on first image sensor 140. Block 730 may be followed by block 740, “DETECTING, BY A FIRST IMAGE SENSOR, AN INTERFERENCE IMAGE CAUSED BY INTERFERENCE BETWEEN THE REFERENCE BEAM AND THE FIRST LIGHT BEAM SCATTERED BY THE OBJECT.”

At block 740, an image of interference caused by the reference light beam and the first light beam scattered by the object may be received by a first image sensor. As depicted in FIG. 1, first image sensor 140 may be configured to detect and receive an image of the interference pattern caused by object light beam L13, which are first light beam L11 being scattered by object 150, and reference light beam L14. Block 740 may be followed by block 750, “CONVERTING, BY A VIDEO SIGNAL GENERATOR, THE DETECTED INTERFERENCE IMAGE INTO A FIRST IMAGE SIGNAL ASSOCIATED WITH THE LIGHT SOURCE.”

At block 750, the image received by the first image sensor may be converted, by a video signal generator, into a first image signal associated with the light source. For example, as shown in FIG. 1, first image sensor 140 may be adapted to receive a first image of the interference pattern and transmit the first image to video signal generator 180, which may be configured to convert the first image into a first image signal associated with light source 110. Block 750 may be followed by block 760, “DETECTING, BY A SECOND IMAGE SENSOR, A SECOND IMAGE OF BACKGROUND OF THE OBJECT AND CONVERTING THE SECOND IMAGE INTO A SECOND IMAGE SIGNAL.”

At block 760, a second image of background of the object may be detected by a second image sensor, and the second image may be converted into a second image signal. As illustrated in FIG. 1, second image sensor 170 may be configured to detect a second image of background 160 of object 150 and convert second image into a second image signal. Alternatively, second image sensor 170 may be further configured to transmit the second image to video signal generator 180, which may be further configured to convert the second image into the second image signal.

In the above embodiments, the first image signal representative of a hologram of an object can be generated along with the second image signal representative of the background of the object. The first image signal and the second image signal may be recorded in a video signal recorder and/or transmitted by a video signal transmitter to a holographic image reconstruction apparatus, such that a holographic image of the object represented by the first image signal can be displayed while being superimposed on a background image represented by the second image signal.

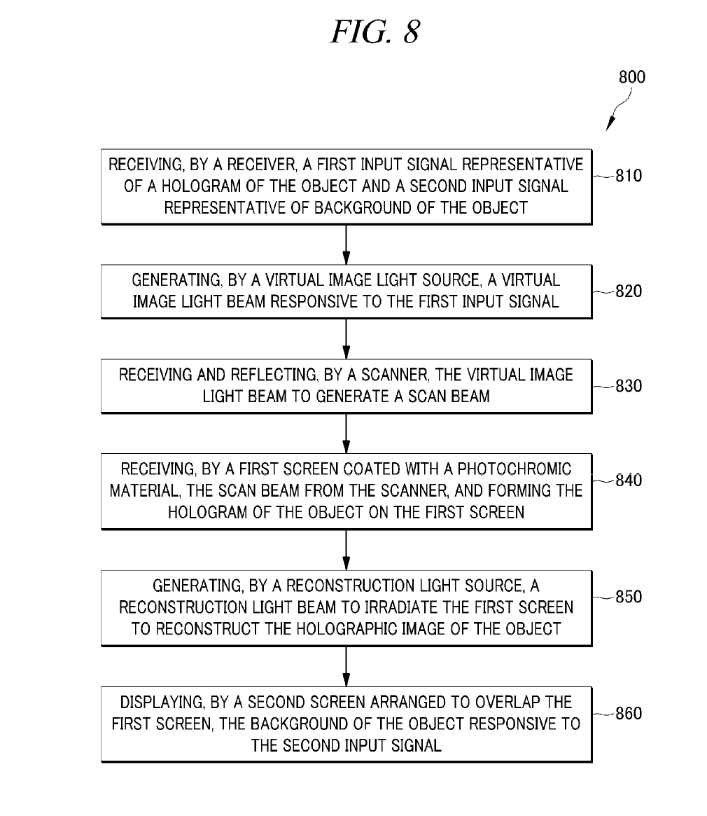

FIG. 8 illustrates an example flow diagram of a method adapted to reconstruct holographic images in accordance with at least some embodiments described herein. An example method 800 in FIG. 8 may be implemented using, for example, a computing device including a processor adapted to reconstruct holographic images.

Method 800 may include one or more operations, actions, or functions as illustrated by one or more of blocks 810, 820, 830, 840, 850 and/or 860. Although illustrated as discrete blocks, various blocks may be divided into additional blocks, combined into fewer blocks, or eliminated, depending on the desired implementation. In some further examples, the various described blocks may be implemented as a parallel process instead of a sequential process, or as a combination thereof. Method 800 may begin at block 810, “RECEIVING, BY A RECEIVER, A FIRST INPUT SIGNAL REPRESENTATIVE OF A HOLOGRAM OF THE OBJECT AND A SECOND INPUT SIGNAL REPRESENTATIVE OF BACKGROUND OF THE OBJECT.”

At block 810, a first input signal representative of a hologram of the object may be received, by a receiver, along with a second input signal representative of background of the object. For example, as depicted in FIGS. 3 and 4, receiver block 340 or video signal receiver 440 may receive a first input signal representative of a hologram of the object and a second input signal representative of background of the object, from holographic image generation apparatus 310 or transmitter block 330 coupled to holographic image generation apparatus 310, through one or more networks 360. Block 810 may be followed by block 820, “GENERATING, BY A VIRTUAL IMAGE LIGHT SOURCE, A VIRTUAL IMAGE LIGHT BEAM RESPONSIVE TO THE FIRST INPUT SIGNAL.”

At block 820, a virtual image light beam may be generated based on the first input signal by a virtual image light source. As illustrated in FIG. 4, a virtual image light source 430 may be arranged to generate a virtual image radiation beam L41 such as a light beam such as an ultraviolet laser beam or an electron beam, based on a holographic image signal such as the first signal representative of a hologram of object 150. In some embodiments, the holographic image signal may be provided from video signal receiver 440, which may receive and store the holographic image signal from a holographic image generation apparatus such as holographic image generation apparatus 100 in FIG. 1. Thus generated virtual image light beam L41 may have intensities which may vary based on the levels of the holographic image signal. Block 820 may be followed by block 830, “RECEIVING AND REFLECTING, BY A SCANNER, THE VIRTUAL IMAGE LIGHT BEAM TO GENERATE A SCAN BEAM.”

At block 830, the virtual image light beam may be received and reflected, by a scanner, to generate a scan beam. As depicted in FIG. 4, in some embodiments, virtual image light source 430 may be configured to provide virtual image light beam L41 onto scanner 420. Scanner 420 may be configured to reflect virtual image light beam L41 and generate scan beam L42 that is irradiated on a first screen 460. Block 830 may be followed by block 840, “RECEIVING, BY A FIRST SCREEN COATED WITH A PHOTOCHROMIC MATERIAL, THE SCAN BEAM FROM THE SCANNER, AND FORMING THE HOLOGRAM OF THE OBJECT ON THE FIRST SCREEN.”

At block 840, the scan beam from the scanner may be received, by a first screen coated with a photochromic material, and the hologram of the object may be formed on the first screen. As depicted in FIGS. 3 to 6B, first screen 460 may be coated with a photochromic material and may be configured to form a hologram of an object, such as object 150, due to a visible light transmittance characteristic of the first screen 460 adjusted in response to scan beam L42. For example, first screen 460 may be a transparent screen including a photochromic material 464 formed on a transparent layer 466. On photochromic material 464 of first screen 460, a hologram that exhibits variation in transmittance characteristics for visible light with a specific wavelength, such as about 440 nm or about 630 nm, may be formed in accordance with the intensity variation of an ultraviolet light such as scan beam L42. Further, when the hologram formed on first screen 460 is irradiated with a hologram reconstruction light with the specific wavelength, such as reconstruction light L43, a holographic image may be reconstructed and viewable by a user. Block 840 may be followed by block 850, “GENERATING, BY A RECONSTRUCTION LIGHT SOURCE, A RECONSTRUCTION LIGHT BEAM TO IRRADIATE THE FIRST SCREEN TO RECONSTRUCT THE HOLOGRAPHIC IMAGE OF THE OBJECT.”

At block 850, a reconstruction light beam from a reconstruction light source may be irradiated on the first screen to reconstruct the holographic image of the object. As shown in FIGS. 4 to 6B, reconstruction light source 410 may be configured to irradiate a reconstruction light beam L43, such as a visible laser beam, on first screen 460. When the hologram formed on first screen 460 are irradiated with the reconstruction light beam, an image of the object may be reconstructed. Block 850 may be followed by block 860, “DISPLAYING, BY A SECOND SCREEN ARRANGED TO OVERLAP THE FIRST SCREEN, THE BACKGROUND OF THE OBJECT RESPONSIVE TO THE SECOND INPUT SIGNAL.”

At block 860, the background of the object may be displayed, by a second screen arranged to overlap the first screen, responsive to the second input signal. As shown in FIG. 4, image projector 450, such as a LCD (liquid crystal display) projector, may be configured to irradiate light beam L44 for projecting an image representative of the background of the object, such as background 160, onto second screen 470. More specifically, image projector 450 may receive an image signal representative of the background of the object, from video signal receiver 440, and irradiate light beam L44 towards first screen 460, though which light beam L passes to reach the surface of second screen 470. Light beam L44 from image project 450 for projecting the image representative of the background of the object may have a wavelength within visible light spectrum (which is higher than 440 nm or 630 nm). Alternatively, second screen 470 may include an LCD screen configured to display the background of the object. In such case, image projector 450 may be omitted in holographic image reconstruction apparatus 400, and the image signal representative of the background of the object may be provided from video signal receiver 440 to second screen 470.

In some examples, the scan beam may be an electron beam, and the scanner may comprise electron optics (such as one or more magnetic lenses, magnetic deflectors, electrical deflectors, and the like, and/or combinations thereof). In some examples, radiation beam expansion may be omitted or achieved using electron optics, and the scan beam may induce a cathodochromic effect in the screen, the screen comprising a cathodochromic material. Further, in some examples, a cathodochromic material and an electron beam may be used in place of a photochromic material and a light beam as described in other examples.

As described above, for the photochromic material coated on the first screen, the ultraviolet light from the virtual image light source may change the transmittance characteristics of the first screen at a specific wavelength such as 440 nm or 630 nm, whereas the transparency of the first screen may be maintained at the other wavelengths. Therefore, the interference pattern formed by the ultraviolet light on the photochromic material does not interfere with the background image displayed on the second screen, and thus, a clear background image can be superimposed on a holographic image of an object.

In some examples, other photochromic materials may be used. The optical characteristics of the photochromic material may be modified by irradiation by a light source having a first wavelength, and the modification detected using a second wavelength. The second wavelength may be a wavelength is chosen to observe an optical response induced by the virtual image radiation beam, such as a photochromic response in the panel induced by the virtual image light beam or an cathodochromic response induced in a cathodochromic material by a virtual image electron beam. In some examples, a laser beam, such as a UV laser beam, creates a photochromic response in a layer of iron-doped potassium tantalate, and this response is particularly apparent at 440 nm. However, other photochromic materials could be used, and other wavelengths of light may be used as the reconstruction light beam, for example including substantially monochromatic light, coherent light, visible light (light may also include near-IR and UV), or blue-violet light. In some examples, the reconstruction light beam may be substantially monochromatic and have a wavelength at which an optical response induced by the virtual image radiation beam is appreciable.

In some embodiments, a photochromic material and/or a cathodochromic material may include one or more crystalline, polycrystalline, or amorphous materials. In some embodiments, a photochromic material and/or a cathodochromic material may include an alkali metal compound (such as a halide or a transition metal oxide of an alkali) or an alkaline earth metal compound (such as an alkaline earth metal halide). In some embodiments, a photochromic material and/or or cathodochromic material may comprise potassium (K), strontium (Sr), barium (Ba), tantalum (Ta), and/or titanium (Ti). An example photochromic material may comprise an alkali (or alkaline earth metal) titanate and/or an alkali (or alkaline earth metal) tantalate, and may include at least one of potassium tantalate (KTaO₃), strontium titanate (SrTiO₃), or barium titanate (BaTiO₃), doped with an impurity such as nickel (Ni) or iron (Fe), which may be represented by KTaO₃:Fe, KTaO₃:Ni, SrTiO₃:Fe, SrTiO₃:Ni, BaTiO₃:Fe, or BaTiO₃:Ni. Additionally or alternatively, a photochromic material and/or cathodochromic material may include an organic material such as HABI (hexaarylbiimidazole).

In some examples, examples described which use a light beam to induce an optical effect in a photochromic material may be modified appropriately to use an electron beam to generate an optical response in a cathodochromic material. For dynamic image changes, such as video displays, the optical response due to the radiation beam may not persist an appreciable time after the radiation beam is removed, for example a light beam and a reversibly photochromic material. In some examples, an erase beam may be used to remove radiation-beam induced effects before a new holograph is written in a screen material (such as a photochromic material). In some examples, the screen may include one or more scotophors, such as a cathodochromic and/or a photochromic material, or other scotophoric material.

In some examples, an apparatus is configured to reconstruct a holographic image of an object, and comprises a receiver configured to receive a first input signal representative of a hologram of the object and a second input signal representative of a background of the object; a virtual image radiation source (such as a laser, other light source such as an LED, electron beam source, and the like) configured to generate a virtual image radiation beam (such as a light beam, which may be a coherent and/or substantially monochromatic light beam, such as a laser beam, or in other examples may be an electron beam, responsive to the first input signal, a scanner configured to receive the virtual image radiation beam and redirect the virtual image radiation beam to generate a scan beam; a first screen coated with a material and configured to receive the scan beam from the scanner, wherein the material has a visible light transmittance characteristic (such as photochromism and/or cathodochromism) that is responsive to the scan beam and effective to form the hologram of the object on the first screen (where the term hologram may refer to a holograph that forms a visually perceived hologram under appropriate illumination), a reconstruction light source configured to generate a reconstruction light beam to irradiate the first screen to reconstruct the holographic image of the object; and, a second screen arranged to overlap the first screen and configured to display the background of the object responsive to the second input signal. The virtual image radiation source may be an electron beam source, laser, other light source, and the like.

One skilled in the art will appreciate that, for this and other methods disclosed herein, the functions performed in the methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

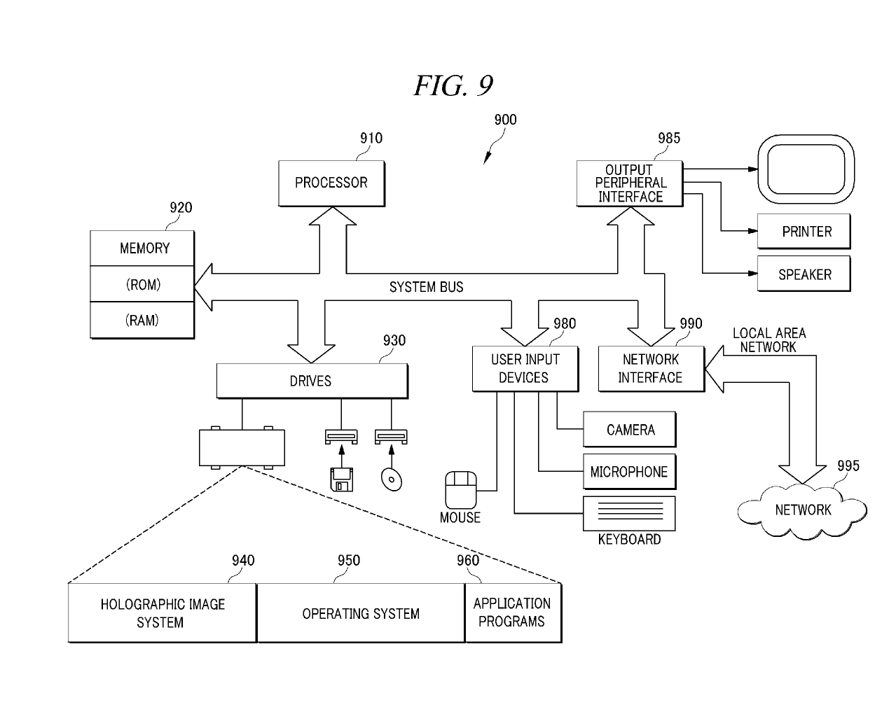

FIG. 9 shows a schematic block diagram illustrating an example computing system that can be configured to perform methods for generating and/or reconstructing holographic images, arranged in accordance with at least some embodiments described herein. As depicted in FIG. 9, a computer 900 may include a processor 910, a memory 920 and one or more drives 930. Computer 900 may be implemented as a conventional computer system, an embedded control computer, a laptop, or a server computer, a mobile device, a set-top box, a kiosk, a vehicular information system, a mobile telephone, a customized machine, or other hardware platform.

Drives 930 and their associated computer storage media may provide storage of computer readable instructions, data structures, program modules and other data for computer 900. Drives 930 may include a holographic image system 940, an operating system (OS) 950, and application programs 960. Holographic image system 940 may be adapted to control a holographic image generation apparatus and/or a holographic image reconstruction apparatus in such a manner as described above with respect to FIGS. 1 to 8.

Computer 900 may further include user input devices 980 through which a user may enter commands and data. Input devices can include an electronic digitizer, a camera, a microphone, a keyboard and pointing device, commonly referred to as a mouse, trackball or touch pad. Other input devices may include a joystick, game pad, satellite dish, scanner, or the like.

These and other input devices can be coupled to processor 910 through a user input interface that is coupled to a system bus, but may be coupled by other interface and bus structures, such as a parallel port, game port or a universal serial bus (USB). Computers such as computer 900 may also include other peripheral output devices such as display devices, which may be coupled through an output peripheral interface 985 or the like.

Computer 900 may operate in a networked environment using logical connections to one or more computers, such as a remote computer coupled to a network interface 990. The remote computer may be a personal computer, a server, a router, a network PC, a peer device or other common network node, and can include many or all of the elements described above relative to computer 900.

Networking environments are commonplace in offices, enterprise-wide area networks (WAN), local area networks (LAN), intranets, and the Internet. When used in a LAN or WLAN networking environment, computer 900 may be coupled to the LAN through network interface 990 or an adapter. When used in a WAN networking environment, computer 900 typically includes a modem or other means for establishing communications over the WAN, such as the Internet or a network 995. The WAN may include the Internet, the illustrated network 995, various other networks, or any combination thereof. It will be appreciated that other mechanisms of establishing a communications link, ring, mesh, bus, cloud, or network between the computers may be used.

In some embodiments, computer 900 may be coupled to a networking environment. Computer 900 may include one or more instances of a physical computer-readable storage medium or media associated with drives 930 or other storage devices. The system bus may enable processor 910 to read code and/or data to/from the computer-readable storage media. The media may represent an apparatus in the form of storage elements that are implemented using any suitable technology, including but not limited to semiconductors, magnetic materials, optical media, electrical storage, electrochemical storage, or any other such storage technology. The media may represent components associated with memory 920, whether characterized as RAM, ROM, flash, or other types of volatile or nonvolatile memory technology. The media may also represent secondary storage, whether implemented as storage drives 930 or otherwise. Hard drive implementations may be characterized as solid state, or may include rotating media storing magnetically encoded information.

Processor 910 may be constructed from any number of transistors or other circuit elements, which may individually or collectively assume any number of states. More specifically, processor 910 may operate as a state machine or finite-state machine. Such a machine may be transformed to a second machine, or specific machine by loading executable instructions. These computer-executable instructions may transform processor 910 by specifying how processor 910 transitions between states, thereby transforming the transistors or other circuit elements constituting processor 910 from a first machine to a second machine. The states of either machine may also be transformed by receiving input from user input devices 980, network interface 990, other peripherals, other interfaces, or one or more users or other actors. Either machine may also transform states, or various physical characteristics of various output devices such as printers, speakers, video displays, or otherwise.

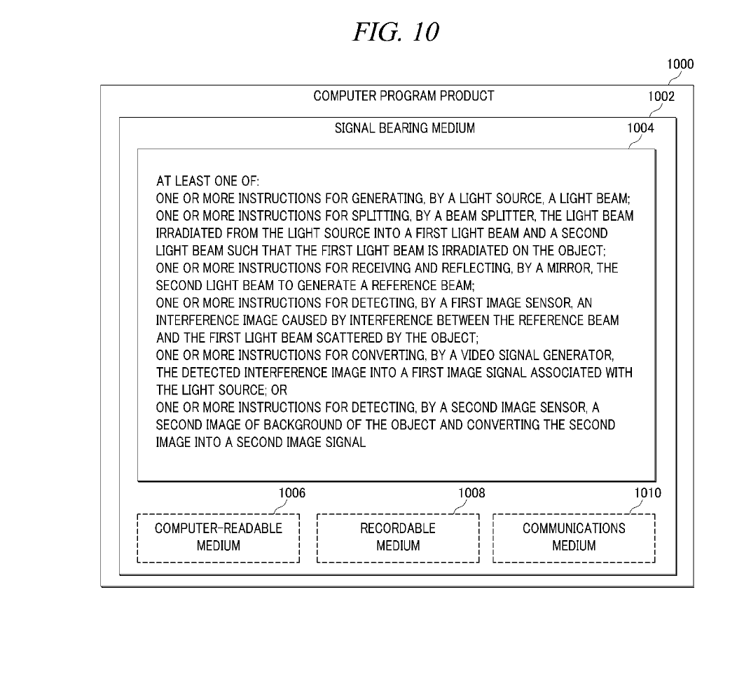

FIG. 10 illustrates computer program products 1000 that can be utilized to operate a holographic image generation apparatus in accordance with at least some embodiments described herein. Program product 1000 may include a signal bearing medium 1002. Signal bearing medium 1002 may include one or more instructions 1004 that, when executed by, for example, a processor, may provide the functionality described above with respect to FIGS. 1 to 8. By way of example, instructions 1004 may include at least one of: one or more instructions for generating, by a light source, a light beam; one or more instructions for splitting, by a beam splitter, the light beam irradiated from the light source into a first light beam and a second light beam such that the first light beam is irradiated on the object; one or more instructions for receiving and reflecting, by a mirror, the second light beam to generate a reference beam; one or more instructions for detecting, by a first image sensor, an interference image caused by interference between the reference beam and the first light beam scattered by the object; one or more instructions for converting, by a video signal generator, the detected interference image into a first image signal associated with the light source; or one or more instructions for detecting, by a second image sensor, a second image of background of the object and converting the second image into a second image signal. Thus, for example, referring to FIGS. 1 to 3, holographic image generation apparatus 100 or holographic image generation block 310 may undertake one or more of the blocks shown in FIG. 7 in response to instructions 1004.

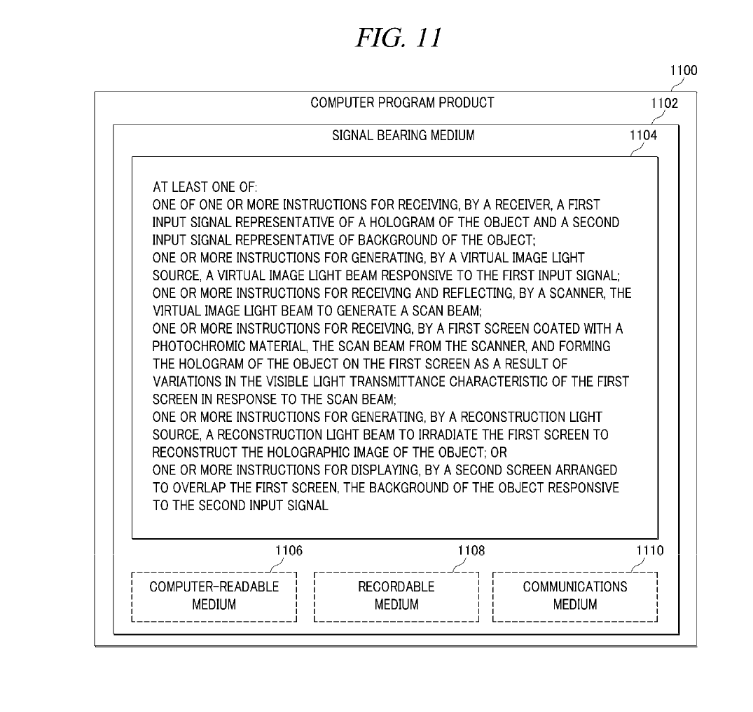

FIG. 11 illustrates computer program products 1100 that can be utilized to operate a holographic image reconstruction apparatus in accordance with at least some embodiments described herein. Program product 1100 may include a signal bearing medium 1102. Signal bearing medium 1102 may include one or more instructions 1104 that, when executed by, for example, a processor, may provide the functionality described above with respect to FIGS. 1 to 8. By way of example, instructions 1104 may include at least one of: one of one or more instructions for receiving, by a receiver, a first input signal representative of a hologram of the object and a second input signal representative of background of the object; one or more instructions for generating, by a virtual image light source, a virtual image light beam responsive to the first input signal; one or more instructions for receiving and reflecting, by a scanner, the virtual image light beam to generate a scan beam; one or more instructions for receiving, by a first screen coated with a photochromic material, the scan beam from the scanner, and forming the hologram of the object on the first screen as a result of variations in the visible light transmittance characteristics of the first screen in response to the scan beam; one or more instructions for generating, by a reconstruction light source, a reconstruction light beam to irradiate the first screen to reconstruct the holographic image of the object; or one or more instructions for displaying, by a second screen arranged to overlap the first screen, the background of the object responsive to the second input signal. Thus, for example, referring to FIGS. 3 to 6B, holographic image reconstruction block 350 or holographic image reconstruction apparatus 400 may undertake one or more of the blocks shown in FIG. 8 in response to instructions 1104.

In some implementations, signal bearing medium 1102 or 1002 may encompass a computer-readable medium 1106 or 1006, such as, but not limited to, a hard disk drive, a Compact Disc (CD), a Digital Video Disk (DVD), a digital tape, memory, etc. In some implementations, signal bearing medium 1102 or 1002 may encompass a recordable medium 1108 or 1008, such as, but not limited to, memory, read/write (R/W) CDs, R/W DVDs, etc. In some implementations, signal bearing medium 1102 or 1002 may encompass a communications medium 1110 or 1010, such as, but not limited to, a digital and/or an analog communication medium (e.g., a fiber optic cable, a waveguide, a wired communications link, a wireless communication link, etc.). Thus, for example, program product 1100 or 1000 may be conveyed to one or more modules of holographic image generation apparatus 100 or holographic image generation apparatus 310, or holographic image reconstruction block 350 or holographic image reconstruction apparatus 400 by an RF signal bearing medium 1102 or 1002, where the signal bearing medium 1102 or 1002 is conveyed by a wireless communications medium 1110 or 1010 (e.g., a wireless communications medium conforming with the IEEE 802.11 standard).

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An apparatus configured to generate a holographic image of an object, the apparatus comprising:
a light source configured to generate a light beam;
a beam splitter configured to receive the light beam from the light source and split the light beam into a first light beam and a second light beam, wherein the beam splitter is also configured to irradiate the first light beam on the object such that at least part of the first light beam is scattered by the object to generate an object light beam;
a minor configured to receive the second light beam from the beam splitter, and reflect at least part of the second light beam to generate a reference light beam;
a first image sensor configured to receive the reference light beam and the object light beam, and also configured to detect a first image of interference caused by the reference light beam and the object light beam;
a video signal generator configured to convert the detected first image into a first image signal associated with the light source; and
a second image sensor configured to detect a second image of background of the object and convert the second image into a second image signal.

2. The apparatus of claim 1, further comprising a video signal recorder configured to record the first and second image signals.

3. The apparatus of claim 1, further comprising a video signal transmitter configured to transmit the first and second image signals, whereby the first and second image signals are operable by a holographic image reconstruction apparatus.

4. The apparatus of claim 1, wherein the first image sensor comprises a charge coupled device (CCD) array.

5. The apparatus of claim 1, wherein the first image sensor comprises a two-dimensional sensor array.

6. The apparatus of claim 1, wherein the second image sensor comprises a CCD sensor.

7. The apparatus of claim 1, wherein the beam splitter comprises an aluminum layer formed on a glass substrate.

8. The apparatus of claim 1, wherein the light source comprises a visible laser light source.

9. The apparatus of claim 1, wherein the light source comprises a light source configured to generate a light having a wavelength of about 440 nm

10. The apparatus of claim 1, further comprising a controller configured to control operation of the video signal generator.

11. The apparatus of claim 10, wherein the controller is configured to store a control program to control operation of the apparatus.

12. An apparatus configured to reconstruct a holographic image of an object, the apparatus comprising:
a receiver configured to receive a first input signal representative of a hologram of the object and a second input signal representative of background of the object;
a virtual image light source configured to generate a virtual image light beam responsive to the first input signal;
a scanner configured to receive the virtual image light beam and reflect the virtual image light beam to generate a scan beam;
a first screen coated with a photochromic material and configured to receive the scan beam from the scanner, wherein the first screen includes a visible light transmittance characteristic that is adjusted in response to the scan beam and effective to form the hologram of the object on the first screen;
a reconstruction light source configured to generate a reconstruction light beam to irradiate the first screen to reconstruct the holographic image of the object; and
a second screen arranged to overlap the first screen and also configured to display the background of the object responsive to the second input signal.

13. The apparatus of claim 12, wherein the first screen comprises the photochromic material formed on a transparent layer.

14. The apparatus of claim 13, wherein the transparent layer comprises a quartz glass material or a borosilicate glass material.

15. The apparatus of claim 13, wherein the transparent layer comprises a transparent plastic material or PET (polyethylene terephthalate) material.

16. The apparatus of claim 13, wherein the photochromic material comprises one or more materials selected from the group consisting of potassium tantalate (KTaO₃) doped with a first impurity and/or strontium titanate (SrTiO₃) doped with a second impurity.

17. The apparatus of claim 16, wherein the first and second impurities comprises nickel (Ni) or iron (Fe).

18. The apparatus of claim 13, wherein the photochromic material comprises potassium tantalate (KTaO₃) doped with iron (Fe).

19. The apparatus of claim 13, wherein the photochromic material comprises HABI (hexaarylbiimidazole).

20. The apparatus of claim 12, wherein the first screen is configured in a shape of a two-dimensional panel.

21. The apparatus of claim 12, wherein the receiver is configured to receive the first and second input signals from a holographic image generation apparatus.

22. The apparatus of claim 12, wherein the virtual image light source is configured to generate an ultraviolet laser beam.

23. The apparatus of claim 12, wherein the reconstruction light source comprises a visible laser light source.

24. The apparatus of claim 12, wherein the reconstruction light source comprises a light source configured to generate a light having a wavelength of about 440 nm.

25. The apparatus of claim 12, wherein the scanner is configured to be magnetically actuated, electrically actuated or electromagnetically actuated.

26. The apparatus of claim 12, wherein the second screen is further configured to receive an image projected from an LCD (liquid crystal display) projector, the image being representative of the background of the object.

27. The apparatus of claim 12, wherein the second screen comprises an LCD screen configured to display the background of the object.

28. A method for generating a holographic image of an object, the method comprising:
generating, by a light source, a light beam;
splitting, by a beam splitter, the light beam irradiated from the light source into a first light beam and a second light beam such that the first light beam is irradiated on the object;
receiving and reflecting, by a minor, the second light beam to generate a reference beam;
detecting, by a first image sensor, an interference image caused by interference between the reference beam and the first light beam scattered by the object;
converting, by a video signal generator, the detected interference image into a first image signal associated with the light source; and
detecting, by a second image sensor, a second image of background of the object and converting the second image into a second image signal.

29. The method of claim 28, further comprising recording, by a video signal recorder, the first and second image signals.

30. The method of claim 28, further comprising transmitting, by a video signal transmitter, the first and second image signals to a holographic image reconstruction apparatus.

31. A method of reconstructing a holographic image of an object, the method comprising:
receiving, by a receiver, a first input signal representative of a hologram of the object and a second input signal representative of background of the object;
generating, by a virtual image light source, a virtual image light beam responsive to the first input signal;
receiving and reflecting, by a scanner, the virtual image light beam to generate a scan beam;
receiving, by a first screen coated with a photochromic material, the scan beam from the scanner, and forming the hologram of the object on the first screen as a result of variations in the visible light transmittance characteristic of the first screen in response to the scan beam;
generating, by a reconstruction light source, a reconstruction light beam to irradiate the first screen to reconstruct the holographic image of the object; and
displaying, by a second screen arranged to overlap the first screen, the background of the object responsive to the second input signal.

32. The method of claim 31, wherein receiving the first and second input signals includes receiving, by the receiver, the first and second input signals from a holographic image generation apparatus.

33. A non-transitory computer-readable storage medium which stores a program for causing a processor configured to generate a holographic image of an object, the program comprising one or more instructions for:
generating, by a light source, a light beam;
splitting, by a beam splitter, the light beam irradiated from the light source into a first light beam and a second light beam such that the first light beam is irradiated on the object;
receiving and reflecting, by a minor, the second light beam to generate a reference beam;
detecting, by a first image sensor, an interference image caused by interference between the reference beam and the first light beam scattered by the object;
converting, by a video signal generator, the detected interference image into a first image signal associated with the light source; and
detecting, by a second image sensor, a second image of background of the object and converting the second image into a second image signal.

34. The medium of claim 33, wherein the program further comprises one or more instructions for recording, by a video signal recorder, the first and second image signals in a storage unit.

35. The medium of claim 33, wherein the program further comprises one or more instructions for transmitting, by a video signal transmitter, the first and second image signals to a holographic image reconstruction apparatus.

36. A non-transitory computer-readable storage medium which stores a program for causing a processor to reconstruct a holographic image of an object, the program comprising one or more instructions for:
receiving, by a receiver, a first input signal representative of a hologram of the object and a second input signal representative of background of the object;
generating, by a virtual image light source, a virtual image light beam responsive to the first input signal;
receiving and reflecting, by a scanner, the virtual image light beam to generate a scan beam;
receiving, by a first screen coated with a photochromic material, the scan beam from the scanner, and forming the hologram of the object on the first screen as a result of variations in the visible light transmittance characteristic of the first screen in response to the scan beam;
generating, by a reconstruction light source, a reconstruction light beam to irradiate the first screen to reconstruct the holographic image of the object; and
displaying, by a second screen arranged to overlap the first screen, the background of the object responsive to the second input signal.

37. The medium of claim 36, wherein the program further comprises one or more instructions for receiving, by the receiver, the first and second input signals from a holographic image generation apparatus.

38. An apparatus configured to reconstruct a holographic image of an object, the apparatus comprising:
a receiver configured to receive a first input signal representative of a hologram of the object and a second input signal representative of background of the object;
a virtual image radiation source configured to generate a virtual image radiation beam responsive to the first input signal;
a scanner configured to receive the virtual image radiation beam and redirect the virtual image radiation beam to generate a scan beam;
a first screen coated with a material and configured to receive the scan beam from the scanner, wherein the material has a visible light transmittance characteristic that is responsive to the scan beam and effective to form the hologram of the object on the first screen;
a reconstruction light source configured to generate a reconstruction light beam to irradiate the first screen to reconstruct the holographic image of the object; and
a second screen arranged to overlap the first screen and also configured to display the background of the object responsive to the second input signal.

39. The apparatus of claim 38, wherein:
the visible light transmittance characteristic is cathodochromism;
the virtual image radiation source is an electron beam source, and
the virtual image radiation beam is an electron beam.

40. The apparatus of claim 38, wherein:
the visible light transmittance characteristic is photochromism;
the virtual image radiation source is a laser, and
the virtual image radiation beam is a laser beam.
